(19) United States
(12) Patent Application Publication
(10) Pub. No.: US 2018/0293072 A1
(43) Pub. Date: Oct. 11, 2018

(54) METHOD AND APPARATUS FOR DETECTING NOP SLED

(71) Applicant: SAMSUNG SDS CO., LTD., Seoul (KR)

(72) Inventors: Yoon Chan JHI, Seoul (KR); Young Jun KUM, Seoul (KR); Jong Hun KIM, Seoul (KR); In Sang JEONG, Seoul (KR)

(73) Assignee: SAMSUNG SDS CO., LTD., Seoul (KR)

(21) Appl. No.: 15/933,522

(22) Filed: Mar. 23, 2018

(30) Foreign Application Priority Data
Apr. 5, 2017 (KR) 10-2017-0044057

(51) Int. Cl. G06F 9/30; G06F 12/0875; G06F 9/38

(52) U.S. Cl. CPC G06F 9/30076; G06F 9/3867; G06F 12/0875

(57) ABSTRACT

Provided is a method of detecting a NOP sled, which is performed by a computing apparatus. The method comprises determining, as a NOP sled characteristic value, a longest consecutive length of at least one of previously found NOP sled patterns, with respect to a plurality of tracking target memory blocks allocated in a memory of the computing apparatus and detecting whether or not a NOP sled occurs based on the NOP sled characteristic value of at least one of the plurality of tracking target memory blocks and a memory block length of the at least one of the plurality of tracking target memory blocks.

This application claims priority from Korean Patent Application No. 10-2017-0044057 filed on Apr. 5, 2017 in the Korean Intellectual Property Office, the disclosure of which is incorporated herein by reference in its entirety.

### BACKGROUND

### 1. Field

The present disclosure relates to a method and apparatus for detecting a NOP sled. More particularly, the present disclosure relates to a method and apparatus for detecting a NOP sled, which can detect a NOP sled sprayed in a heap memory with high accuracy even when patterns of the NOP sled are various, but does not require an excessive computing load for detecting the NOP sled.

### 2. Description of the Related Art

A NOP (no operation) instruction refers to an instruction that performs no operation. The NOP instruction is defined by various operation codes (OPCODEs) for each CPU architecture. For example, in Intel x86-series CPU, 0x90 is defined as NOP.

A simple form of NOP sled has a structure in which the NOPs are connected to each other. Therefore, in this case, even if the NOP sled is executed from any start address, as a result, an execution pointer (program counter or PC) only moves to the end point of the NOP sled, and no operation is performed. A complicated form of NOP sled uses NOP equivalent instructions not influencing the operation of a program, just like the NOP, among instructions consisting of a plurality of bytes. The NOP sled consisting of NOP equivalent instructions is manipulated to be interpreted as NOP equivalent instructions, even if the NOP sled is executed at any byte offset. In this case, even if the NOP sled is executed from any start address, an execution pointer moves to the end point of the NOP sled as a result. In this respect, a concept of the execution pointer being slid can be understood.

If an execution target code is recorded (written) immediately next to the NOP sled, it is guaranteed that the execution target code is necessarily executed as a result, regardless of whether the execution target code is executed from any point in an area where the NOP sled exists. When an attacker is able to manipulate the execution pointer of a program to an arbitrary memory address, it is a well-known malicious code execution method to record (write) several parts of the NOP sled in a memory and attach a malicious code next to the memory in order to increase the probability that the execution point will settle in an area of the NOP sled.

Therefore, in order to block or detect the execution of a malicious code in advance, it is important to detect that the NOP sled is being recorded (written) in the memory. However, since the NOP sled may be configured in various patterns, it is very difficult to accurately detect whether or not the data recorded (written) in the memory is a NOP sled.

### SUMMARY

An aspect of the present disclosure is to provide a method of accurately detecting a NOP sled having various configurations and a computing apparatus for performing the method.

Another aspect of the present disclosure is to provide a method of rapidly detecting a NOP sled having various configurations and a computing apparatus for performing the method.

Still another aspect of the present disclosure is to provide a method of accurately detecting data without executing a series of operations in order to detect whether or not the series of operations recorded (written) in a memory correspond to a NOP sled, and a computing apparatus for performing the method.

According to an embodiment of the present disclosure, there is provided a method of detecting a NOP sled, which is performed by a computing apparatus. The method comprises determining, as a NOP sled characteristic value, a longest consecutive length of at least one of previously found NOP sled patterns, with respect to a plurality of tracking target memory blocks allocated in a memory of the computing apparatus and detecting whether or not a NOP sled occurs based on the NOP sled characteristic value of at least one of the plurality of tracking target memory blocks and a memory block length of the at least one of the plurality of tracking target memory blocks.

According to another embodiment of the present disclosure, there is provided an apparatus for detecting a NOP sled. The apparatus comprises a hardware processor and a memory configured to load a computer program executed by the hardware processor, wherein the computer program, when executed by the hardware processor, causes the hardware processor to perform operations comprising determining, as a NOP sled characteristic value, a longest consecutive length of one of previously found NOP sled patterns, with respect to a plurality of tracking target memory blocks allocated in the memory and detecting whether a NOP sled occurs based on the NOP sled characteristic value of at least one of the plurality of tracking target memory blocks and a memory block length of the at least one of the plurality of tracking target memory blocks.

According to still another embodiment of the present disclosure, there is provided a non-transitory computer-readable storage medium storing a computer program which, when executed by a computing apparatus, causes the computing apparatus to perform determining, as a NOP sled characteristic value, a longest consecutive length of at least one of previously found NOP sled patterns, with respect to a plurality of tracking target memory blocks allocated in a memory of the computing apparatus and detecting whether or not a NOP sled occurs based on the NOP sled characteristic value of at least one of the plurality of tracking target memory blocks and a memory block length of the at least one of the plurality of tracking target memory blocks.

According to another embodiment of the present disclosure, there is provided a computing apparatus comprising: a processor configured to: initialize a memory area; register the initialized memory area into a plurality of tracking target memory blocks; determine, as a NOP sled characteristic value, a longest consecutive length of at least one of previously found NOP sled patterns, with respect to the plurality of tracking target memory blocks; and detect whether a NOP sled occurs based on the NOP sled characteristic value of at least one of the plurality of tracking target memory blocks and a memory block length of the at least one of the plurality of tracking target memory blocks; and block, in response to detecting that the NOP sled has occurred, execution of a malicious code corresponding to the detected NOP sled.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a configuration diagram of a computing apparatus having a function of detecting a NOP sled according to an embodiment of the present disclosure;

FIG. 2 is a diagram showing an example of a NOP sled to be detected in some embodiments of the present disclosure;

FIGS. 3 and 4 are flowcharts of a method of detecting a NOP sled according to another embodiment of the present disclosure;

FIG. 5A is a diagram showing examples of previously found NOP sled patterns that are referenced in some embodiments of the present disclosure;

FIGS. 5B to 5E are views for explaining examples in which tracking target memory blocks are classified according to the position where the NOP sled pattern is found and the connection length of the NOP sled pattern; and

FIG. 6 is a flowchart for explaining some operations of FIG. 4 in more detail.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Like numbers refer to like elements throughout.

Unless otherwise defined, all terms including technical and scientific terms used herein have the same meaning as commonly understood by one of ordinary skill in the art to which this disclosure belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, embodiments of the present disclosure will be described with reference to the attached drawings.

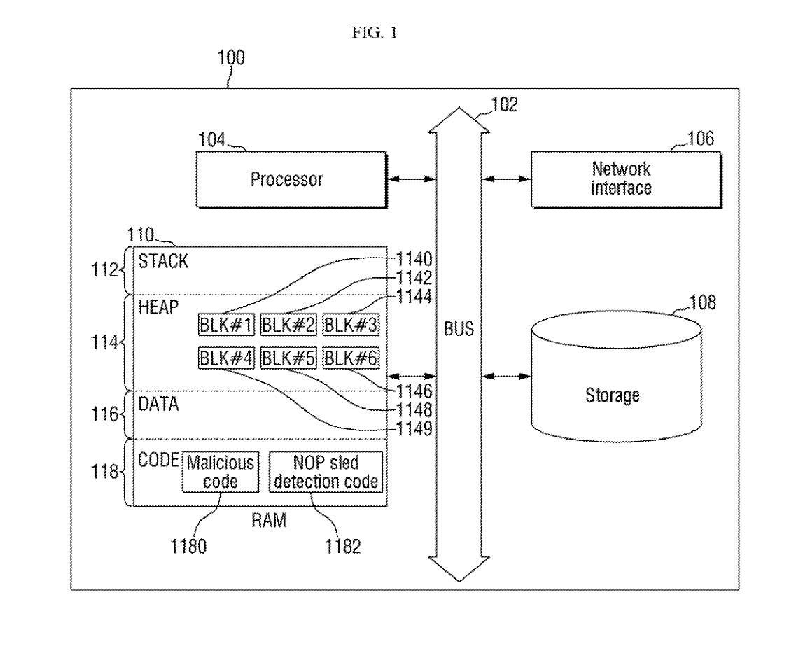

FIG. 1 is a configuration diagram of a computing apparatus having a function of detecting a NOP sled according to an embodiment of the present disclosure. Hereinafter, the configuration and operation of the computing apparatus having a function of detecting a NOP sled (hereinafter, referred to as “a NOP sled detection apparatus) according to this embodiment will be described with reference to FIG. 1.

The NOP sled detection apparatus 100 according to this embodiment includes a processor 104, a network interface 106, a storage 108, a memory 110, and a system bus 102 for relaying the data transmission and reception among the processor 104, the network interface 106, the storage 108, and the memory 110. The memory 110 is a random access memory (RAM).

The storage 108 stores data of software for detecting the NOP sled (for example, a binary file of software for detecting the NOP sled). The storage 108 may additionally store data about previously found NOP sled patterns.

In response to the input of a command of a user of the NOP sled detection apparatus 100 or the occurrence of a predefined trigger, the data of software for detecting the NOP sled is loaded into the memory 110. In FIG. 1, the data of software for detecting the NOP sled, loaded in the memory 110, is indicated by a NOP sled detection code 1182. For example, the NOP sled detection code 1182 may be loaded into a CODE area 118 of the memory 110. In relation to the memory 110 of FIG. 1, it is reflected that an operating system (OS) of the NOP sled detection apparatus 100 can operate the memory 110 by dividing the memory 110 into a stack area 112, a heap area 114, a data area 116, and a code area 118.

FIG. 1 shows that a malicious code 1180 is loaded in the code area 118 of the memory 110. As used herein, the malicious code records (writes) the NOP sled in the memory 110, and concatenates and records operations to be executed by the malicious code 1180 (hereinafter, referred to as “shell code”) immediately next to the recorded (written) NOP sled, thereby executing the shell code without the command of the user of the NOP sled detection apparatus 100 or against the intention of the user. In this respect, this code is expressed as a “malicious” code.

The malicious code 1180 may be loaded into the memory 110 when a specific trigger is satisfied in a state in which the malicious code 1180 is stored in the storage 108, or may be received from an external device through the network interface 106 and immediately loaded into the memory 110.

One or more memory blocks may be allocated to the malicious code 1180 through a memory allocation request in order to record (write) the NOP sled. The memory allocation request may be a memory allocation request function in which a required memory size is stored as a parameter. The memory allocation request function is, for example, a malloc ( ) function of C-language or a HeapAlloc ( ) function of Windows API. The malloc ( ) function reserves a space of a required size in the heap area 114 and allocates the reserved space to a process having called the malloc ( ) function. FIG. 1 shows six memory blocks 1140, 1142, 1144, 1146, 1148, and 1149 allocated to the malicious code 1180. The malicious code 1180 will record (write) the NOP sled and the shell code directly connected to the end of the NOP sled in the allocated memory blocks.

The NOP sled detection code 1182 detects whether or not the NOP sled is recorded (written) in the memory blocks 1140, 1142, 1144, 1146, 1148, and 1149 assigned to the malicious code 1180. Hereinafter, the operations of the NOP sled detection code 1182 will be schematically described.

First operation: a hooking callback function is set for the memory allocation request. As a result, if the malicious code 1180 calls the memory allocation request, the hooking callback function will be called accordingly. The hooking callback function may include a routine of initializing a memory area allocated according to the memory allocation request and a routine of registering the initialized memory area into any one of the plurality of tracking target memory blocks. The initializing the memory area is, for example, erasing the entire memory area in an initial state. By initializing the memory area, existing data in the memory area acts as noise, thereby preventing the NOP sled from being erroneously detected. The hooking callback function may register the memory area into any one of the plurality of tracking target memory blocks only when the size of the memory block allocated according to the memory allocation request is equal to or greater than a first threshold limit value.

In an embodiment, each hooking callback function may be set not only for the memory allocation request but also for a memory reallocation request or a memory release (FREE) request, so as to more precisely monitor the memory-related activity of the malicious code.

Second operation: a NOP sled detection operation is periodically/aperiodically performed according to the occurrence of the specified trigger. The second operation includes the steps of: determining the longest consecutive length of any one of previously found NOP sled patterns as a NOP sled characteristic value of the memory block for the plurality of tracking target memory blocks; selecting valid memory blocks each having a NOP sled characteristic value equal to or greater than a second threshold limit value from the plurality of tracking target memory blocks; and determining whether or not the NOP sled occurs using the NOP sled characteristic values of the valid memory blocks and the lengths of the memory blocks.

Heretofore, the configuration and operation of the NOP sled detection apparatus according to this embodiment have been described. Next, a NOP sled detection method according to another embodiment of the present disclosure will be described. It goes without saying that some of the technical characteristics presented in the description of the NOP sled detection method may be applied to the aforementioned NOP sled detection apparatus. That is, the description of the NOP sled detection apparatus may be supplemented in more detail by the description of the NOP sled detection method to be described below.

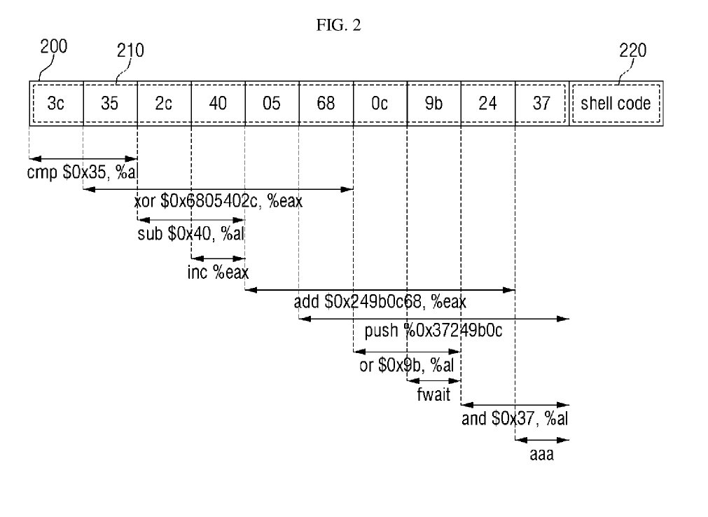

In order to fully explain the NOP sled detection method, a NOP sled which can be detected in some embodiments of the present disclosure will be described with reference to FIG. 2 for the sake of clarity.

As already mentioned, the NOP sled is i) a structure in which a plurality of 1 byte operations indicating NOP operations are connected to each other (first case), or ii) data of a plurality of bytes configured to allow an execution pointer to move to the end point of the NOP sled as a result even if the NOP sled is executed from any start address (second case).

FIG. 2 shows that a NOP sled 210 and a shell code 220 connected immediately next to the NOP sled 210 are recorded (written) in a memory block 200 assigned to the memory. The NOP sled 210 shown in FIG. 2 is the NOP sled of second case. The reason for this will be explained.

When an application currently loaded in the memory (hereinafter referred to as a ‘user application’) accesses from the start time (hereinafter referred to as ‘START-OFFSET’) of the NOP sled 210 and tries to execute an operation, CMP, SUB, ADD, and AAA commands are sequentially executed, and then, as a result, the shell code 220 is executed. When the user application accesses from the address of START-OFFSET+1BYTE and tries to execute an operation, XOR, OR, and AND commands are sequentially executed, and then, as a result, the shell code 220 is executed. When the user application accesses from the address of START-OFFSET+2BYTE and tries to execute an operation, SUB, ADD, and AAA commands are sequentially executed, and then, as a result, the shell code 220 is executed. When the user application accesses from the address of START-OFFSET+3BYTE and tries to execute an operation, INC, ADD, and AAA commands are sequentially executed, and then, as a result, the shell code 220 is executed. When the user application accesses from the address of START-OFFSET+4BYTE and tries to execute an operation, ADD and AAA commands are sequentially executed, and then, as a result, the shell code 220 is executed. When the user application accesses from the address of START-OFFSET+5BYTE and tries to execute an operation, a PUSH command is executed, and then, as a result, the shell code 220 is executed. When the user application accesses from the address of START-OFFSET+6BYTE and tries to execute an operation, OR and AND commands are sequentially executed, and then, as a result, the shell code 220 is executed. When the user application accesses from the address of START-OFFSET+7BYTE and tries to execute an operation, FWAIT and AND commands are sequentially executed, and then, as a result, the shell code 220 is executed. When the user application accesses from the address of START-OFFSET+8BYTE and tries to execute an operation, an AND command is executed, and then, as a result, the shell code 220 is executed. When the user application accesses from the address of START-OFFSET+9BYTE and tries to execute an operation, an AAA command is executed, and then, as a result, the shell code 220 is executed. When the user application accesses from the address of START-OFFSET+10BYTE and tries to execute an operation, the shell code 220 is executed.

As described above, even if any address of an address area of (START-OFFSET, START-OFFSET+10 bytes) is set as a start address of an area to be operated, the shell code 220 is executed as a result. However, the NOP sled shown in FIG. 2 is merely an example of the NOP sled of second case. Considering that there may be a variety of NOP sleds of second case having a predetermined length, but there may also be a variety of NOP sleds of second case having various lengths, it is almost impossible to secure all the NOP sleds of second case that can be made for each length.

In order to solve such a problem, the inventors of the present application intend to propose that the NOP sled of second case can be quickly and accurately detected when an N-GRAM-based pattern matching method is applied. Through many tests and simulations, it was confirmed that a 2-byte bi-GRAM-based pattern matching method, among the N-GRAM-based pattern matching methods, is particularly effective.

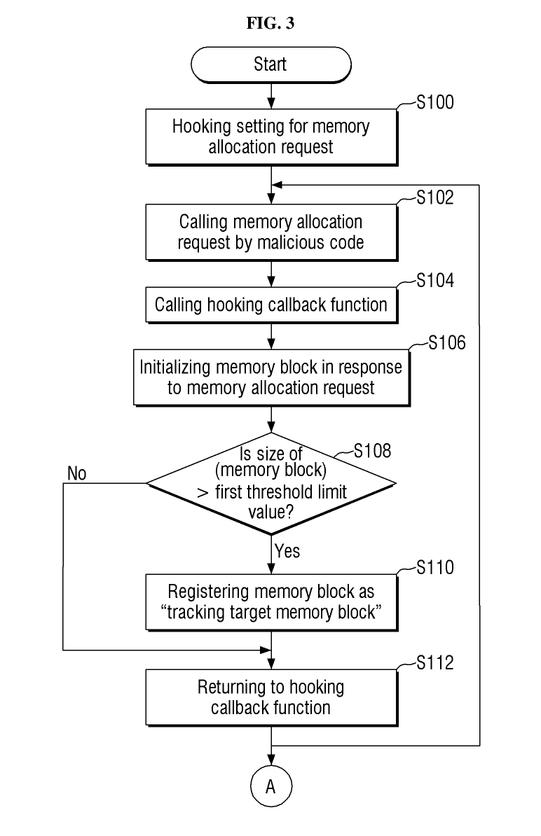

The inventors of the present application have collected NOP sleds of second case generated by a NOP sled pattern generator, and have collected bi-GRAMs found in the collected NOP sleds, so as to obtain bi-GRAMs found in the NOP sled pattern of second case. In some embodiments, NOP sled detection may be performed by the N-GRAM pattern matching with the obtained bi-GRAMs. Hereinafter, the NOP sled detection method according to an embodiment of the present disclosure will be described in more detail with reference to FIGS. 3 to 6.

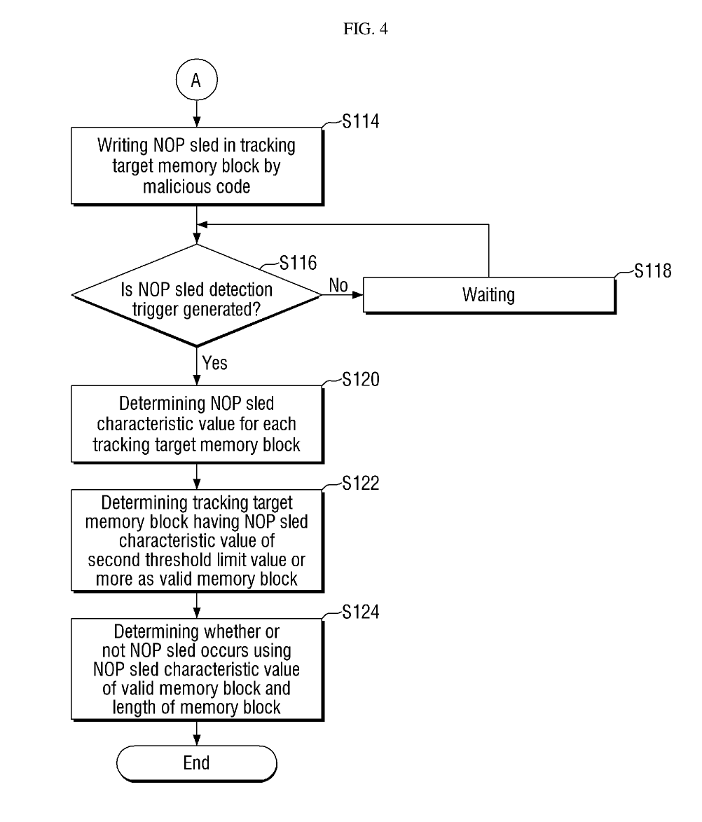

FIGS. 3 and 4 are flowcharts of the NOP sled detection method. The flowcharts of FIGS. 3 and 4 can be understood to refer to each operation performed by the NOP sled detection apparatus depending on the execution of the NOP sled detection code of FIG. 1.

First, a description will be made with reference to FIG. 3. Hook setting for a memory allocation request is executed (S100). The memory allocation request is, for example, a malloc ( ) function. Thus, the hooking setting is, for example, hooking setting for a specific API. When the hook setting (S100) is successfully completed, a hooking callback function is called in response to allowing the malicious code to call the memory allocation request to write the NOP sled (S102) (S104).

The hooking callback function initializes a memory block according to the memory allocation request (S106), and registers the memory block as a “tracking target memory block” (S110). The tracking target memory block indicates a memory block to be monitored in a detection routine that is performed periodically/aperiodically later. After all the routines included in the hooking callback function are executed, control returns to allow the routine of the memory allocation request to be executed (S112).

In an embodiment, only some of the memory blocks according to the memory allocation request may be registered as the tracking target memory blocks. The criterion of the memory block registered as the tracking target memory block may be the size of the memory block. In this case, only the memory block whose size is equal to or greater than a first threshold limit value may be registered as the tracking target memory block (S110).

The first threshold limit value may be a fixed data size. The first threshold limit value may be 1 kilobyte. The first threshold limit value may be a data size that varies dynamically depending on the situation. For example, the first threshold limit value may be a value corresponding to a few lower percentage of the average request size of the memory allocation request.

The criterion of the memory block registered as the tracking target memory block may be information about a process having called the memory allocation request. For example, only when the information about the process having called the memory allocation request included in a process table satisfies predetermined criteria, the memory block according to the memory allocation request called by the process may also be registered as the tracking target memory block.

Unlike that shown in FIG. 3, if the size of the memory block according to the memory allocation request does not reach the first threshold limit value after the hooking callback function is called (S104), the hooking callback function may immediately return (S112).

Next, a description will be made with reference to FIG. 4. It is assumed that the malicious code has executed NOP sled writing in at least one of the tracking target memory blocks (S114).

Upon generation of a previously designated trigger (S116), a NOP sled detection routine is executed. The previously designated trigger is periodically/aperiodically generated. For example, the predetermined trigger may be generated by a timer of a predetermined period, or may be generated when the number of memory allocation requests reaches a predetermined number (for example, 100) or the total sum of request sizes according to the memory allocation requests reaches a predetermined size (for example, 100 mega bytes).

The NOP sled detection routine includes the operations of: determining a NOP sled characteristic value for each tracking target memory block (S120); determining a valid memory from the tracking target memory blocks (S122); and determining whether or not a NOP sled occurs (S124). Hereinafter, each of the operations will be described in more detail.

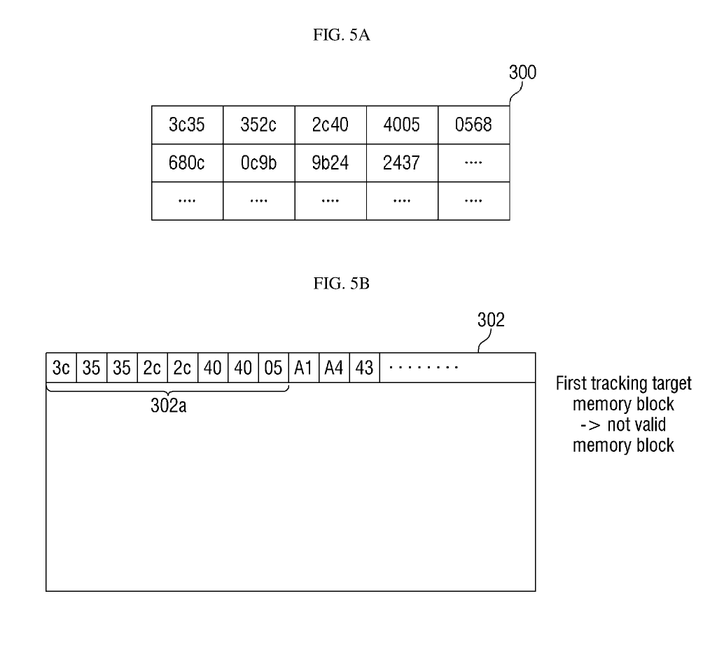

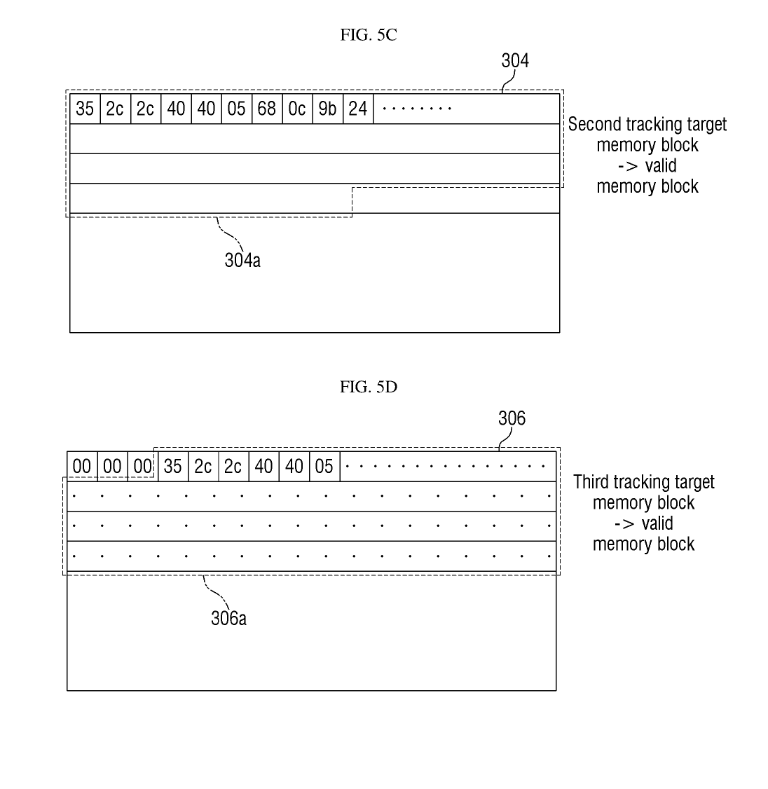

The NOP sled characteristic value of the tracking target memory block refers to the longest consecutive length of any one of the previously found NOP sled patterns in the tracking target memory block. The previously found NOP sled patterns refer to data pieces connected back and forth to constitute the NOP sled. In this respect, each of the NOP sled patterns is N-GRAM. FIG. 5A is an example of the previously found NOP sled patterns. FIG. 5A shows NOP sled patterns 300 that are bi-GRAMs.

Hereinafter, some embodiments that can be applied to the operation of determining a NOP sled characteristic value for each tracking target memory block (S120) and the operation of determining a valid memory from the tracking target memory blocks (S122) will be described.

In an embodiment, among the tracking target memory blocks, only the tracking target memory whose NOP sled characteristic value is equal to or greater than the second threshold limit value may be selected as the valid memory block.

The inventors of the present disclosure have found after a long time simulation work that NOP sled detection can be accurately performed when the second threshold limit value is set to a value of 20 bytes to 30 bytes. In particular, the inventors have found that NOP sled detection can be most accurately performed when the second threshold limit value is set to a value of 25 bytes. Hereinafter, details will be described on the assumption that the second threshold limit value is 25 bytes.

In an embodiment, the NOP sled characteristic value refers to the longest consecutive length of any one of the previously found NOP sled patterns 300 from the start address of a memory block.

In the case of the first tracking target memory block 302 shown in FIG. 5B, a total of four bi-GRAM NOP sled patterns are connected (302a) from the start address of the first tracking target memory block 302. That is, the NOP sled characteristic value of the first tracking target memory block 302 is 8 bytes, and 8 bytes are less than the second threshold limit value. Therefore, the first tracking target memory block 302 is not selected as a valid memory block. Meanwhile, in the case of the first tracking target memory block 304 shown in FIG. 5C, a total of one hundred bi-GRAM NOP sled patterns are connected (304a) from the start address of the second tracking target memory block 304 (it is assumed in FIG. 5C that one hundred bi-GRAM NOP sled patterns are not shown to be accurately divided, but the connection of one hundred NOP sled patterns is omitted). That is, the NOP sled characteristic value of the second tracking target memory block 304 is 200 bytes, and 200 bytes are equal to or more than the second threshold limit value. Therefore, the second tracking target memory block 304 is selected as a valid memory block.

In an embodiment, with respect to the memory block, the NOP sled characteristic value refers to a consecutive length of any one of the previously found NOP sled patterns 300 from a start address of each memory block or from an address within the fourth threshold limit value from the start address thereof. This embodiment is prepared for the case where the malicious code avoids NOP sled pattern detection because the first few bytes of the allocated memory block do not intentionally write the NOP sled pattern.

For example, the fourth threshold limit value may be a natural number of 3 bytes to 10 bytes. A method for processing the third tracking target memory block 306 of FIG. 5D will be described on the assumption that the fourth threshold limit value is 4 bytes. Since ‘0000’ is not included in the NOP sled patterns 300 shown in FIG. 5A, the NOP sled pattern is not written in the start address of the third tracking target memory block 306. However, One hundred of the NOP sled patterns 300 are consecutive from the point of start address+3 bytes of the third target memory block 306 (it is assumed in FIG. 5C that one hundred bi-GRAM NOP sled patterns are not shown to be accurately divided, but the connection of one hundred NOP sled patterns is omitted). That is, the NOP sled characteristic value of the third tracking target memory block 306 is 200 bytes, and 200 bytes are equal to or more than the second threshold limit value. Therefore, the third tracking target memory block 306 is selected as a valid memory block.

In an embodiment, with respect to the memory block, successively found lengths of any one of the previously found NOP sled patterns are collected, and the longest length of the found lengths is determined as the NOP characteristic value of the memory block. The nth tracking target memory block 308 shown in FIG. 5E is provided with a NOP sled pattern consecutive section 308a having a length of 500 bytes, a NOP sled pattern consecutive section 308b having a length of 150 bytes, and a NOP sled pattern consecutive section 308c having a length of 170 bytes. In this case, the NOP sled characteristic value of the nth tracking target memory block 308 is 500, which is the longest consecutive length.

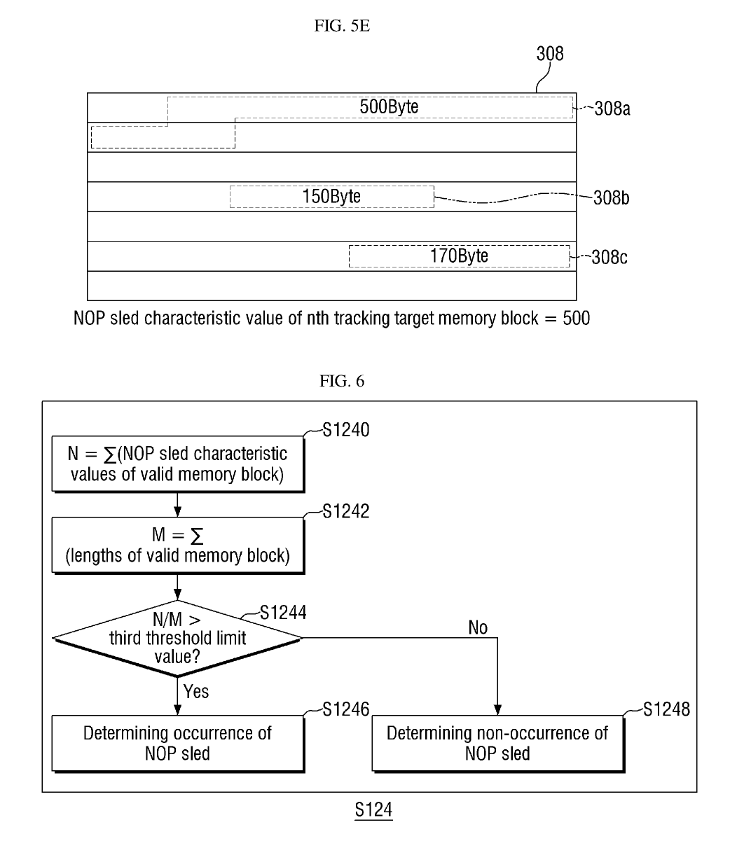

An operation of determining whether or not the NOP sled occurs only using the NOP sled characteristic values of the valid memory blocks and the lengths of the valid memory blocks will be described with reference to FIG. 6. The reason why the valid memory block is separately selected is that some memory blocks in which a small number of NOP sled patterns are detected are excluded in the procedure of determining the NOP sled.

First, the NOP sled characteristic values of all the valid memory blocks are summed to calculate an N value (S1240), and the lengths of all the valid memory blocks are summed to calculate an M value (S1242).

When the N/M value is equal to or greater than the third threshold limit value (S1244), it is determined that the NOP sled occurs (S1246), and a subsequent routine such as warning message output is executed. When the N/M value is less than the third threshold limit value (S1244), it is determined that the NOP sled does not occur (S1248).

As a result of simulation and testing by the inventors of the present disclosure, it has been found that the third threshold limit value may have a wide range from 0.1 to 0.9. This indicates that the NOP sled detection method based on the N/M value very effectively separates NOP sled occurrence from NOP sled non-occurrence.

The methods according to the embodiments of the present disclosure, having been described so far, may be performed by the execution of a computer program implemented in computer-readable codes. The computer program may be transmitted from a first computing apparatus to a second computing apparatus through a network such as the Internet, and installed in the second computing apparatus, thereby enabling this computer program to be used in the second computing apparatus. The first computing apparatus and the second computing apparatus all include a server device, a physical server belonging to a server pool for a cloud service, and a fixed computing apparatus such as a desktop PC.

The computer program may be stored in a recording medium such as DVD-ROM or a flash memory device.

The concepts of the disclosure described above with reference to FIGS. 1 to 6 can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A method of detecting a No Operation (NOP) sled performed by a computing apparatus, the method comprising:
determining, as a NOP sled characteristic value, a longest consecutive length of at least one of previously found NOP sled patterns, with respect to a plurality of tracking target memory blocks allocated in a memory of the computing apparatus; and
detecting whether or not a NOP sled occurs based on the NOP sled characteristic value of at least one of the plurality of tracking target memory blocks and a memory block length of the at least one of the plurality of tracking target memory blocks.

2. The method of claim 1, further comprising:
before the determining the longest consecutive length of the at least one of the previously found NOP sled patterns as the NOP sled characteristic value, executing a hooking callback function preset with respect to a memory allocation request in response to a call to the memory allocation request,
wherein the executing the hooking callback function comprises:
initializing a memory area allocated in response to the memory allocation request; and
registering the initialized memory area into one of the plurality of tracking target memory blocks.

3. The method of claim 2,
wherein the initializing the allocated memory area comprises preventing data recorded in the allocated memory area from being recognized as one of the previously found NOP sled patterns.

4. The method of claim 2,
wherein the registering the initialized memory area comprises registering the initialized memory area into one of the plurality of tracking target memory blocks in response to determining that a size of the allocated memory area is equal to or greater than a first threshold limit value.

5. The method of claim 1,
wherein the determining the longest consecutive length of the at least one of the previously found NOP sled patterns as the NOP sled characteristic value comprises collecting consecutive lengths of one of the previously found NOP sled patterns with respect to the plurality of tracking target memory blocks and determining a longest length of the collected consecutive lengths as the NOP sled characteristic value of the one of the plurality of tracking target memory blocks.

6. The method of claim 1,
wherein the determining the longest consecutive length of the at least one of previously found NOP sled pattern as the NOP sled characteristic value comprises determining a consecutive length of one of the previously found NOP sled patterns as the NOP sled characteristic value of the one of the plurality of tracking target memory blocks by monitoring each of the plurality of tracking target memory blocks from a start address of each of the plurality of tracking target memory blocks or from an address within a fourth threshold limit value from the start address of each of the plurality of tracking target memory blocks.

7. The method of claim 1,
wherein the detecting whether or not the NOP sled occurs comprises:
determining a valid memory block, among the plurality of tracking target memory blocks, the valid memory block having the NOP sled characteristic value equal to or greater than a second threshold limit value; and
determining whether or not the NOP sled occurs using the NOP sled characteristic value of the valid memory blocks and the memory block length of the valid memory block.

8. The method of claim 7,
wherein the second threshold limit value is between 20 bytes to 30 bytes.

9. The method of claim 8,
wherein the second threshold limit value is 25 bytes.

10. The method of claim 7,
wherein the determining whether or not the NOP sled occurs using the NOP sled characteristic value and the length comprises determining whether or not the NOP sled occurs based on a first value obtained by adding the NOP sled characteristic values of all valid memory blocks and a second value obtained by adding the memory block lengths of all the valid memory blocks.

11. The method of claim 10,
wherein the determining whether or not the NOP sled occurs using the first value and the second value comprises determining that the NOP sled occurs in response to determining that a value obtained by dividing the first value by the second value is equal to or greater than a third threshold limit value.

12. The method of claim 1,
wherein the previously found NOP sled patterns are based on N-GRAM, where N is a natural number of 2 or more.

13. The method of claim 12,
wherein the previously found NOP sled patterns are based on bi-GRAM.

14. The method of claim 1, further comprising:
blocking, in response to detecting that the NOP sled has occurred, execution of a malicious code corresponding to the detected NOP sled.

15. An apparatus for detecting a No Operation (NOP) sled, comprising:
a hardware processor; and
a memory configured to load a computer program executed by the hardware processor,
wherein the computer program, when executed by the hardware processor, causes the hardware processor to perform operations comprising:
determining, as a NOP sled characteristic value, a longest consecutive length of one of previously found NOP sled patterns, with respect to a plurality of tracking target memory blocks allocated in the memory; and
detecting whether a NOP sled occurs based on the NOP sled characteristic value of at least one of the plurality of tracking target memory blocks and a memory block length of the at least one of the plurality of tracking target memory blocks.

16. The apparatus of claim 15, where the computer program, when executed by the hardware processor, causes the hardware processor to further perform operations comprising:
blocking, in response to detecting that the NOP sled has occurred, execution of a malicious code corresponding to the detected NOP sled.

17. A computing apparatus comprising:
a processor configured to:
initialize a memory area;
register the initialized memory area into a plurality of tracking target memory blocks;
determine, as a NOP sled characteristic value, a longest consecutive length of at least one of previously found NOP sled patterns, with respect to the plurality of tracking target memory blocks;
detect whether a NOP sled occurs based on the NOP sled characteristic value of at least one of the plurality of tracking target memory blocks and a memory block length of the at least one of the plurality of tracking target memory blocks; and
block, in response to detecting that the NOP sled has occurred, execution of a malicious code corresponding to the detected NOP sled.

18. The computing apparatus of claim 17, wherein the processor is further configured to determine a consecutive length of one of the previously found NOP sled patterns as the NOP sled characteristic value of the one of the plurality of tracking target memory blocks by monitoring each of the plurality of tracking target memory blocks from a start address of each of the plurality of tracking target memory blocks or from an address within a fourth threshold limit value from the start address of each of the plurality of tracking target memory blocks.
